(19) United States
(12) Patent Application Publication
(10) Pub. No.: US 2011/0089652 A1
(43) Pub. Date: Apr. 21, 2011

(54) MATERIAL HANDLING CART AND METHOD OF ASSEMBLING THE SAME

(76) Inventors: Robert H. Unnerstall, JR., St. Charles, MO (US); Robert B. Helms, Festus, MO (US); Rich Osterreicher, St. Charles, MO (US); Mark Harsy, O'Fallon, MO (US)

(21) Appl. No.: 12/580,460

(22) Filed: Oct. 16, 2009

(51) Int. Cl. B62D 39/00; B23P 11/00

(52) U.S. Cl. 280/33.996; 280/33.997; 29/428

(57) ABSTRACT

A material handling cart for transporting a load of materials is provided. The material handling cart includes a base frame, a support frame coupled to the base frame, and a shelf coupled to at least one of the support frame and the base frame, the shelf pivotable between a raised position in which the shelf is adjacent the support frame and a lowered position in which the shelf is seated atop of the base frame, the shelf configured to receive the load of materials. The material handling cart also includes a flexible restraining member removably coupled to the support frame, the flexible restraining member configured to be adjustably tensioned about the load of materials to secure the load of materials to the base frame and the support frame during transport.

### BACKGROUND OF THE INVENTION

The subject matter described herein relates generally to carts and, more particularly, to a material handling cart and a method of assembling the same.

At least some known material handling carts are used to manually transport a load of materials (e.g., raw materials, finished products, foodstuffs, etc.) from one location to another. Moreover, at least some known material handling carts include wheels that enable a user to transport a load of materials included within the cart by rolling the cart from one place to another.

However, a load of materials may be heavy and/or cumbersome (e.g., the load may contain packages of materials that are stacked atop of one another), and a terrain over which the load is to be rolled may present obstacles such as, for example, street curbs or door thresholds. Yet, at least some known material handling carts fail to provide a mechanism for securing the load during transport, much less provide a mechanism that is adjustable to suit the size of the particular load being transported. As such, operators of these known material handling carts expend significant time and effort carefully balancing and strenuously lifting the loaded carts over obstacles during transport and have resorted to wrapping each individual load in a disposable cellophane-like material to aid in securing the load. However, the use of a disposable restraint for each load of materials has significant economic and environmental costs.

Additionally, the availability of space to store and/or transport loaded and unloaded material handling carts is often limited. Yet, many known material handling carts are not shaped to make the most efficient use of the limited space. Specifically, at least some known material handling carts are shaped such that significant space is often wasted when arranging a group of carts side-by-side during storage and/or transport. For example, at least some known carts have rigid handles that extend outward and result in wasted space when carts are arranged side-by-side. Thus, many cart operators resort to stacking unloaded material handling carts on top of one another during storage. However, storage space is still wasted when carts are stacked on one another (not to mention that many such carts are heavy and awkward to lift), and wasted space increases the costs associated with storing and/or transporting loaded and unloaded material handling carts.

As such, it would be useful to provide a material handling cart with an adjustable and flexible restraining member and a lift assist handle that minimize time and effort expended when manually transporting a load of materials from one location to another. It would also be useful to provide a material handling cart that is configured to nest with other carts resulting in improved use of storage and transport space. Also, it would be useful to provide a material handling cart having a reusable mechanism for securing a load during transport.

### BRIEF DESCRIPTION OF THE INVENTION

In one aspect, a material handling cart for transporting a load of materials is provided. The material handling cart includes a base frame, a support frame coupled to the base frame, and a shelf coupled to at least one of the support frame and the base frame, the shelf pivotable between a raised position in which the shelf is adjacent the support frame and a lowered position in which the shelf is seated atop of the base frame, the shelf configured to receive the load of materials. The material handling cart also includes a flexible restraining member removably coupled to the support frame, the flexible restraining member configured to be adjustably tensioned about the load of materials to secure the load of materials to the base frame and the support frame during transport.

In another aspect, a material handling cart for transporting a load of materials is provided. The material handling cart includes a base frame, a support frame coupled to the base frame, and a lift assist handle hingedly coupled to at least one of the base frame and the support frame, the lift assist handle pivotable between a stowed position that is substantially parallel to the support frame and a lift position that is oblique to the support frame for lifting the material handling cart during transport.

In another aspect, a method of assembling a material handling cart for transporting a load of materials is provided. The method includes providing a base frame, coupling a support frame to the base frame, and coupling a shelf to at least one of the support frame and the base frame, the shelf pivotable between a raised position in which the shelf is adjacent the support frame and a lowered position in which the shelf is seated atop of the base frame, the shelf configured to receive the load of materials. The method also includes removably coupling a flexible restraining member to the support frame, the flexible restraining member configured to be adjustably tensioned about the load of materials to secure the load of materials to the base frame and the support frame during transport.

### BRIEF DESCRIPTION OF THE DRAWINGS

FIG. 1 is a perspective view of a material handling cart;

FIG. 2 is a front elevation view of the material handling cart shown in FIG. 1;

FIG. 3 is a side elevation view of the material handling cart shown in FIG. 1;

FIG. 4 is a plan view of a base frame of the material handling cart shown in FIG. 1;

FIG. 5 is a perspective view of a shelf of the material handling cart shown in FIG. 1;

FIG. 6 is a perspective view of a portion of a flexible restraining apparatus of the material handling cart shown in FIG. 1;

FIG. 7 is an enlarged perspective view of the portion of the flexible restraining apparatus shown in FIG. 6 and taken within portion 7;

FIG. 8 is a perspective view of a plurality of the material handling carts shown in FIG. 1 loaded with materials and arranged side-by-side on a lift apparatus; and

FIG. 9 is a perspective view of a plurality of the material handling carts shown in FIG. 1 nested together.

### DETAILED DESCRIPTION OF THE INVENTION

The exemplary embodiments described herein provide a material handling cart that is useful in transporting a load of materials from one location to another and storing the material handling cart when the material handling cart is either loaded or unloaded. Specifically, the material handling cart described herein includes a lift assist handle for lifting the loaded cart over an obstacle during transport. For example, when the cart is used to move a load of materials into or out of a storage space (e.g., a truck, a building, etc.), the lift assist handle can be used to lift at least a portion of the load and/or the cart over the threshold or other obstacle.

Moreover, the material handling cart includes a hitch for coupling the cart to a second and/or third cart for transporting a series of carts together. In one embodiment, the series of carts can be towed by a vehicle, such as a loader, through a building and/or lot. Additionally, the material handling cart is useful in efficiently utilizing the limited space in which loaded and unloaded carts can be stored. Specifically, the material handling cart has a substantially rectangular shelf and a substantially straight support frame (i.e., the material handling cart, when loaded with materials, has a substantially rectangular footprint) for storing a group of loaded material handling carts side-by-side (e.g., on a truck bed) without wasted space between adjacent carts. Also, the material handling cart has a base frame that defines a tapered slot sized to receive the base frame of a second cart such that multiple, unloaded material handling carts can be nested together in storage, thereby minimizing the space needed to store a group of unloaded carts. Further, by storing the carts in a side-by-side nested fashion, an operator is not required to lift the carts when storing the carts or removing the carts from storage.

The embodiments described herein further include a reusable net that is adjustable to conform to a size and/or shape of the load being transported. The tension of the net can be adjusted about the load such that the net tightly secures the load against the material handling cart during transport. Moreover, the net can be rolled up and stored on the material handling cart when the material handling cart is not in use. Additionally, when the net begins to show signs of wear, the net can be replaced, and the new net can be used to transport additional loads.

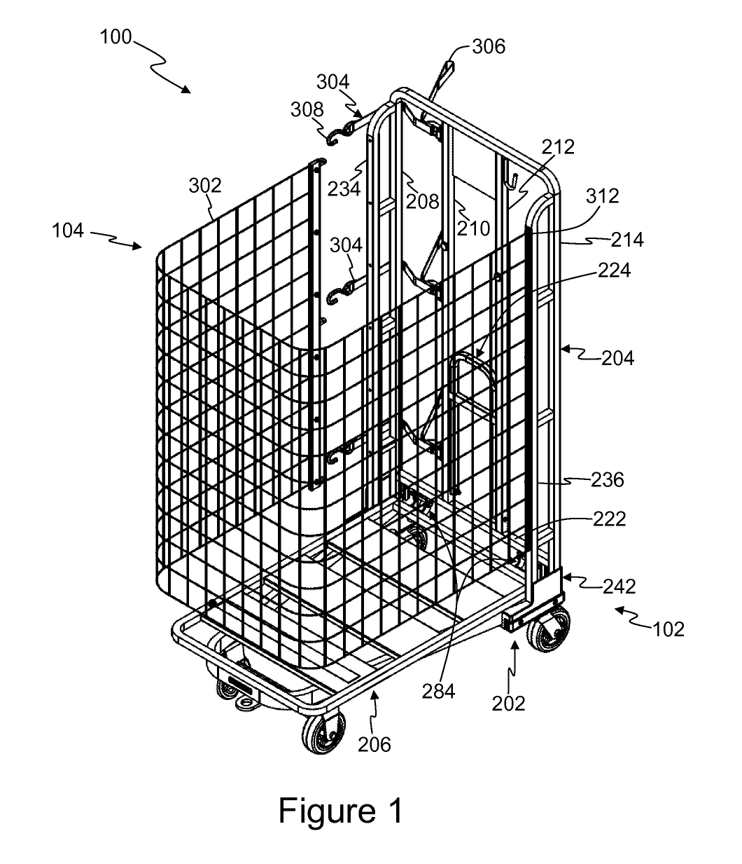

FIG. 1 is a perspective view of an exemplary material handling cart 100. In the exemplary embodiment, material handling cart 100 includes a frame assembly 102 and a flexible restraining apparatus 104 coupled to frame assembly 102 to secure a load of materials (e.g., a stack of packaged materials) to frame assembly 102 when transporting the load of materials from one location to another. As used herein, the term “material” broadly refers to any article (e.g., food, clothing, tools, electronics, etc.) that can be transported and is not limited to articles that are to be processed. In one embodiment, a “load of materials” is a stack of packaged articles, such as, for example, a stack of boxes. In other embodiments, a “load of materials” may be a group of articles situated in any suitable manner.

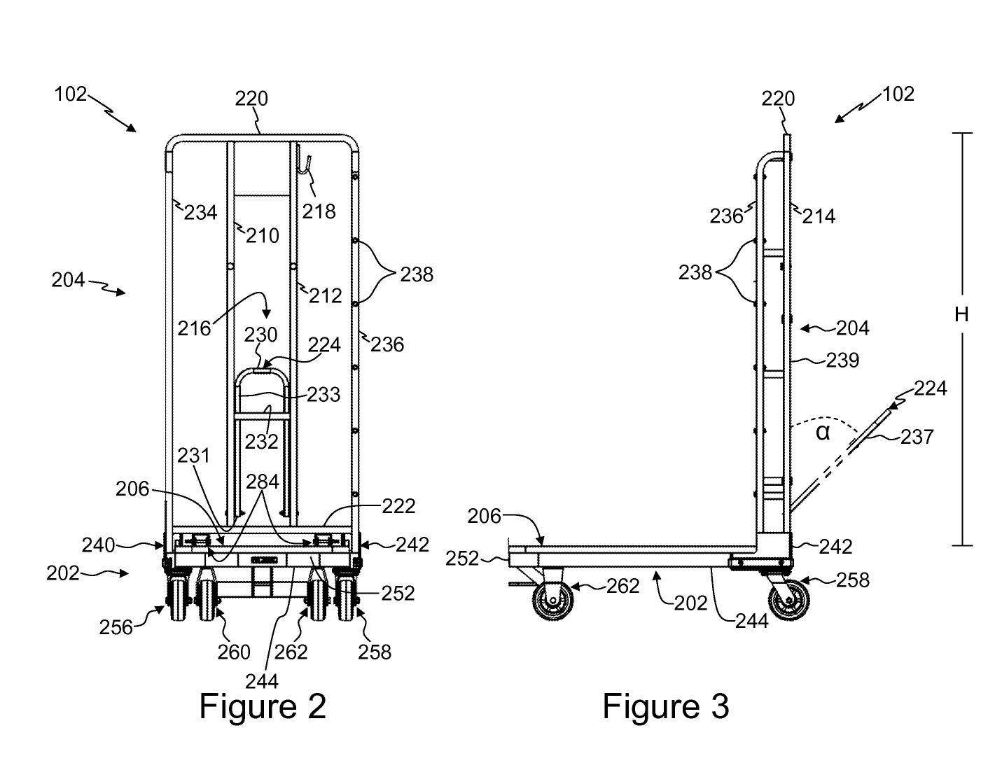

FIG. 2 is a front elevation view of frame assembly 102. FIG. 3 is a side elevation view of frame assembly 102. In the exemplary embodiment, frame assembly 102 includes a base frame 202, a support frame 204, and a shelf 206. Support frame 204 includes a first outer frame member 208 (shown in FIG. 1), a first inner frame member 210, a second inner frame member 212, and a second outer frame member 214 extending substantially parallel to one another. First inner frame member 210 is spaced apart from first outer frame member 208, and second inner frame member 212 is spaced apart from second outer frame member 214. First inner frame member 210 and second inner frame member 212 are spaced apart from one another to define a channel 216. In one embodiment, a hanger 218 is coupled to second inner frame member 212 to store a portion of flexible restraining apparatus 104 on frame assembly 102 when flexible restraining apparatus 104 is not in use, as described below. In alternative embodiments, hanger 218 may be placed at any suitable location on support frame 204, or support frame 204 may include any suitable mechanism that facilitates storing flexible restraining apparatus 104 as described herein.

In the exemplary embodiment, support frame 204 also includes an upper frame member 220 that extends from first outer frame member 208 to second outer frame member 214 across top portions of first inner frame member 210 and second inner frame member 212. Similarly, support frame 204 includes a lower frame member 222 that extends from first outer frame member 208 to second outer frame member 214 across bottom portions of first inner frame member 210 and second inner frame member 212. In one embodiment, first outer frame member 208, first inner frame member 210, second inner frame member 212, second outer frame member 214, upper frame member 220, and lower frame member 222 may be formed integrally together (i.e., formed from a single, continuous, and unjointed material). In another embodiment, first outer frame member 208, first inner frame member 210, second inner frame member 212, second outer frame member 214, upper frame member 220, and/or lower frame member 222 may be formed separately from one another and coupled together using any suitable fastener(s). Alternatively, support frame 204 may include any suitable number of frame members arranged in any suitable manner that enables support frame 204 to function as described herein.

In the exemplary embodiment, a lift assist handle 224 is hingedly coupled (e.g., bolted) to first inner frame member 210 and second inner frame member 212 proximate lower frame member 222. Lift assist handle 224 is pivotable between a stowed position (shown in FIG. 2), in which lift assist handle 224 is removably (e.g., via a magnet, a snap-fit fastener, a hook and loop fastener, etc.) coupled within channel 216 and substantially parallel to inner frame members 210, 212, and a lift position (shown in FIG. 3), in which lift assist handle 224 extends outwardly at an oblique angle α relative to inner frame members 210, 212 to facilitate lifting at least a portion of material handling cart 100 over an obstacle, as described below. In the exemplary embodiment, angle α of lift assist handle 224 in the lift position may be any suitable angle selected by the user. In some embodiments, lift assist handle 224 may be configured to be pivoted into a predetermined angle α (e.g., a mechanical limit stop may be provided on at least one of base frame 202, support frame 204, and lift assist handle 224 to facilitate preventing lift assist handle 224 from being pivoted beyond angle α). In other embodiments, an oblique orientation of lift assist handle 224 in the lift position may be selected from any one of a plurality of predetermined oblique orientations. In the exemplary embodiment, lift assist handle 224 has a handle outer surface 237, and support frame 204 has a support frame outer surface 239 such that handle outer surface 237 is substantially coplanar with support frame outer surface 239 when lift assist handle 224 is in the stowed position to enable support frame 204 to be positioned flush against a flat surface of an adjacent object (e.g., a wall, another cart, etc.) during storage or transport.

In the exemplary embodiment, lift assist handle 224 includes a proximal end 231 and a distal end 233 such that lift assist handle 224 is hingedly coupled to support frame 204 at proximal end 231. An upper arm 230 is disposed proximate distal end 233, and a lower arm 232 is disposed between proximal end 231 and upper arm 230 to enable a user to grasp lift assist handle 224 with either one or two hands when lifting at least a portion of material handling cart 100 over an obstacle, as described below. In alternative embodiments, lift assist handle 224 may include any suitable number of arms and may be coupled to any suitable frame member(s) of support frame 204 in any suitable manner that enables lift assist handle 224 to function as described herein.

In the exemplary embodiment, support frame 204 also includes a first guiderail 234 and a second guiderail 236 that project outwardly from and extend along a length of first outer frame member 208 and second outer frame member 214, respectively. In one embodiment, a plurality of bolt holes 238 are formed in second guiderail 236 to facilitate removably coupling flexible restraining apparatus 104 to support frame 204, as described below. In other embodiments, flexible restraining apparatus 104 may be coupled to support frame 204 in any suitable manner. In the exemplary embodiment, first outer frame member 208 and first guiderail 234 are rigidly coupled to base frame 202 at a first joint 240, and second outer frame member 214 and second guiderail 236 are rigidly coupled to base frame 202 at a second joint 242 such that support frame 204 has a height H defined from base frame 202 to upper frame member 220.

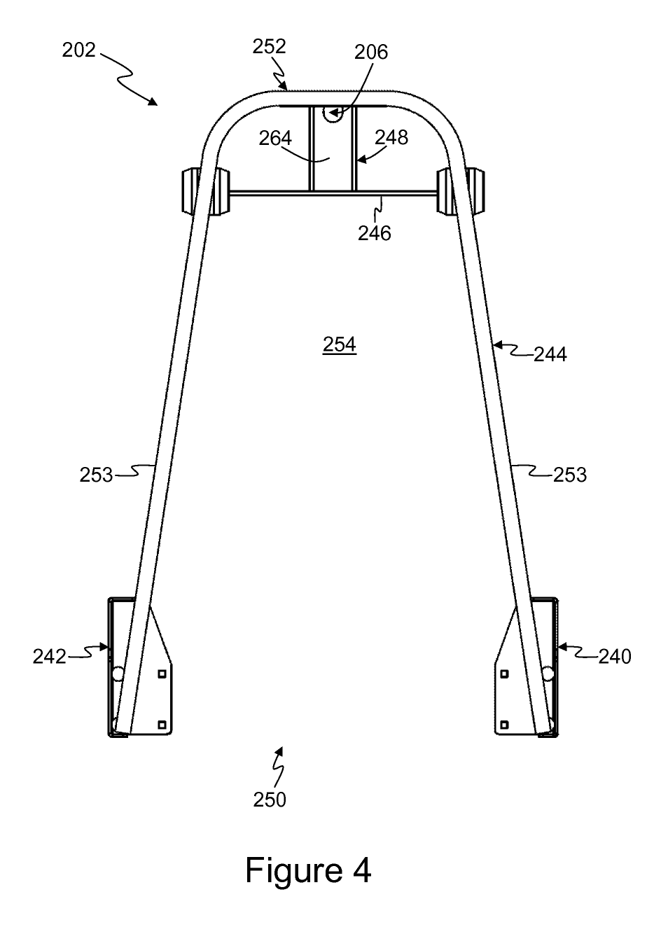

FIG. 4 is a plan view of base frame 202. In the exemplary embodiment, base frame 202 includes a base frame member 244, a crossbar 246, and a hitch 248. Base frame member 244 is arcuately shaped and extends from an open first end 250 to a closed second end 252 to define a pair of opposing sides 253 and a slot 254 tapered in a direction from first end 250 to second end 252 and sized to receive a base frame 202 of another material handling cart 100, as described below. As shown in FIGS. 1-3, base frame 202 is coupled to first joint 240 and second joint 242 proximate first end 250 such that base frame 202 is rigidly coupled to support frame 204 in a substantially perpendicular orientation. In other embodiments, base frame 202 may have any suitable configuration of frame member(s) coupled to support frame 204 in any suitable manner that facilitates enabling base frame 202 to function as described herein.

In the exemplary embodiment, as shown in FIGS. 2 and 3, a first caster assembly 256 and a second caster assembly 258 are coupled to opposing sides of base frame member 244 proximate first end 250 (e.g., first caster assembly 256 is coupled to first joint 240, and second caster assembly 258 is coupled to second joint 242), and a third caster assembly 260 and a fourth caster assembly 262 are coupled to opposing sides of base frame member 244 proximate second end 252. In one embodiment, crossbar 246 extends across tapered slot 254, and hitch 248 is supported within tapered slot 254 by crossbar 246. In one embodiment, hitch 248 is formed as a tongue 264 that extends outwardly from crossbar 246 to define a pin slot 266. In other embodiments, hitch 248 may have any suitable configuration that enables hitch 248 to function as described herein.

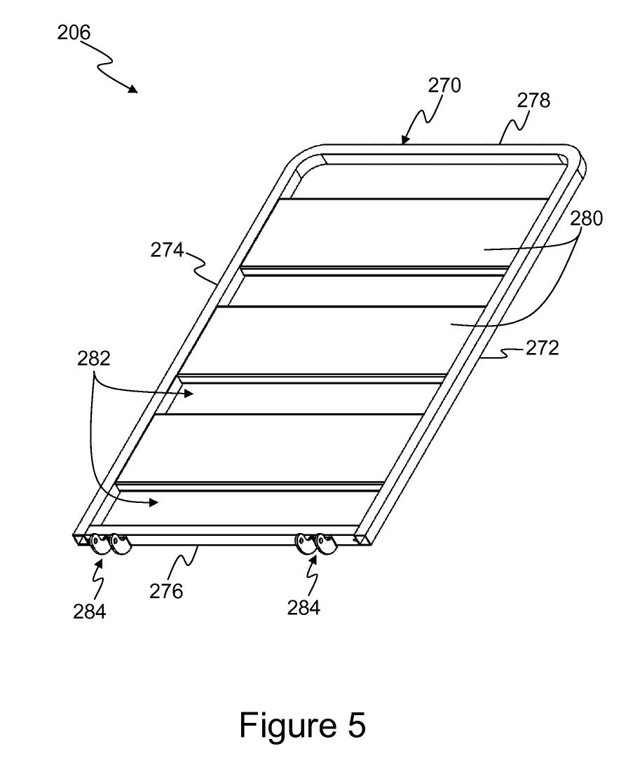

FIG. 5 is a perspective view of shelf 206. In the exemplary embodiment, shelf 206 includes a substantially rectangular shelf frame 270 that includes a first side 272, a second side 274, a third side 276, and a fourth side 278. Third side 276 is formed separately from and coupled between first side 272 and second side 274, and fourth side 278 is integrally formed with first side 272 and second side 274 opposite third side 276. Alternatively, shelf 206 may include any suitable number of sides that are either coupled together or integrally formed with one another in any suitable configuration.

In the exemplary embodiment, a plurality of substantially parallel beams 280 extends between first side 272 and second side 274 to define a plurality of gaps 282. In other embodiments, shelf 206 may have any suitable shape (i.e., shelf may not be substantially rectangular), beams 280 may extend between third side 276 and fourth side 278, and/or shelf may not have gaps 282. Alternatively, shelf 206 may have any suitable configuration that facilitates enabling shelf 206 to function as described herein. In the exemplary embodiment, as shown in FIG. 1, shelf 206 is hingedly coupled to support frame 204 (e.g., hingedly coupled to lower frame member 222) via a plurality of hinges 284 such that shelf 206 is pivotable between a lowered position and a raised position. In the lowered position, shelf 206 extends substantially perpendicular to support frame 204 and is seated on base frame 202. In the raised position, shelf 206 extends substantially perpendicular to base frame 202 and is secured against support frame 204 (e.g., via a magnet, a snap-fit fastener, a hook and loop fastener, etc.). In other embodiments, shelf 206 may be hingedly coupled to base frame 202 and/or support frame 204, or shelf 206 may not be pivotable and may be fixedly coupled to support frame 204 and/or base frame 202 (i.e., shelf 206 may be fixedly seated on base frame 202).

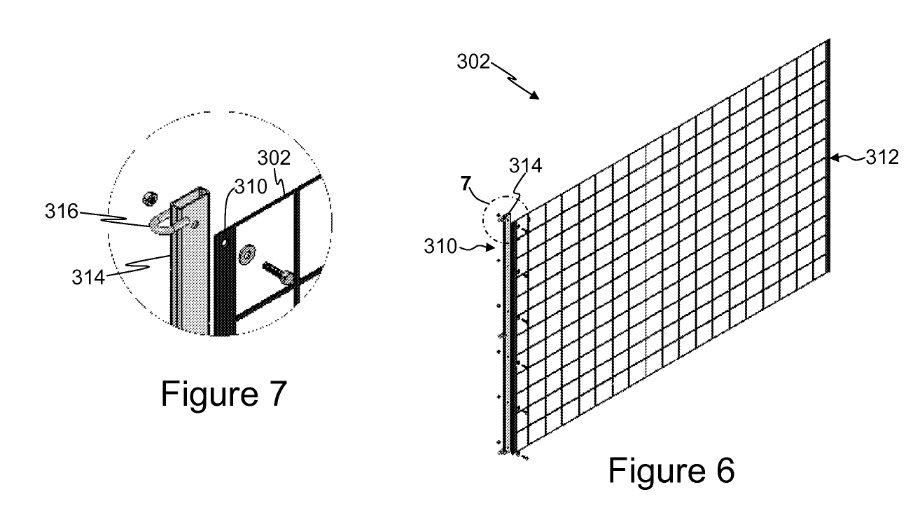

FIG. 6 is a perspective view of a portion of flexible restraining apparatus 104. FIG. 7 is an enlarged perspective view of the portion of flexible restraining apparatus 104 shown in FIG. 6 and taken within portion 7. In the exemplary embodiment, as shown in FIG. 1, flexible restraining apparatus 104 includes a flexible restraining member (e.g., a net 302) and a plurality of adjustable fasteners (e.g., a plurality of tie-down straps 304 having handles 306 and hooks 308). In other embodiments, flexible restraining apparatus 104 may include any suitable flexible restraining member (e.g., a sheet of material) and/or any suitable adjustable fasteners (e.g., ratchet straps). In the exemplary embodiment, net 302 is substantially rectangular in shape and includes a first end 310 and a second end 312. In one embodiment, net 302 is resiliently stretchable (i.e., stretchable without substantial permanent deformation) to conform to a size and shape of a load of materials and to enable adjustable tensioning of net 302 via tie-down straps 304, as described below. In some embodiments, net 302 is sized to substantially envelop the load of materials. In other embodiments, net 302 may have different strength capabilities, such as, for example, a strength that enables net 302 to secure heavy loads (e.g., loads in excess of 500 lbs.) and a strength that enables net 302 to secure lighter loads (e.g., loads of less than 200 lbs.). Alternatively, net 302 may have any suitable configuration that enables net 302 to function as described herein.

A staff 314 is coupled (e.g., bolted) to first end 310, and staff 314 includes a plurality of hoops 316. In other embodiments, flexible restraining apparatus 104 may not include staff 314, or staff 314 may not include hoops 316 and may have any other suitable components (e.g., slots) that facilitate enabling flexible restraining apparatus 104 to function as described herein. As shown in FIG. 1, second end 312 of net 302 is removably fastened to second guiderail 236 (e.g., second end 312 is bolted to second guiderail 236 via bolt holes 238 to substantially span height H of support frame 204) and tie-down straps 304 are coupled to first inner frame member 210 via any suitable fastener(s) (e.g., screws, nails, and/or adhesives) to facilitate fastening and/or unfastening first end 310 of net 302 (i.e., fastening or unfastening staff 314) and tie-down straps 304, as described below.

In an exemplary operation of material handling cart 100, a user may transport a load of materials from one location to another in the following manner. Material handling cart 100 is first erected on a generally flat surface (e.g., a floor, a road, a truck bed, a loading dock, etc.) with caster assemblies 256, 258, 260, 262 contacting the surface, with base frame 202 generally parallel to the surface, with support frame 204 generally perpendicular to the surface, and with lift assist handle 224 in the stowed position. Shelf 206 is pivoted into the lowered position (i.e., shelf 206 is seated on base frame 202), and a load of materials (e.g., a stack of packaged materials) is placed on shelf 206 such that the load of materials is vertically arranged against inner frame members 210, 212 and between guiderails 234, 236 such that the load of materials is vertically supported above the surface by base frame 202 and shelf 206.

With the materials loaded onto shelf 206, first end 310 of net 302 is fastened to support frame proximate first guiderail 234 by inserting hooks 308 of tie-down straps 304 through hoops 316 of staff 314 and tightening tie-down straps 304 via handles 306 such that net 302 is secured tightly around the load of materials and conforms to a size and/or shape of the load of materials. With the load secured tightly against support frame 204 via net 302, the user may grasp support frame 204 (e.g., the user may grasp upper frame member 220, first outer frame member 208, and/or second outer frame member 214) to facilitate rolling material handling cart 100 to a particular location via caster assemblies 256, 258, 260, 262. In some embodiments, the user may couple multiple, loaded material handling carts 100 together by securing a tow bar to hitch 248 of one material handling cart 100 and coupling the tow bar to another material handling cart 100 proximate first and second caster assemblies 256, 258 to facilitate enabling the user to roll multiple material handling carts 100 together as a train.

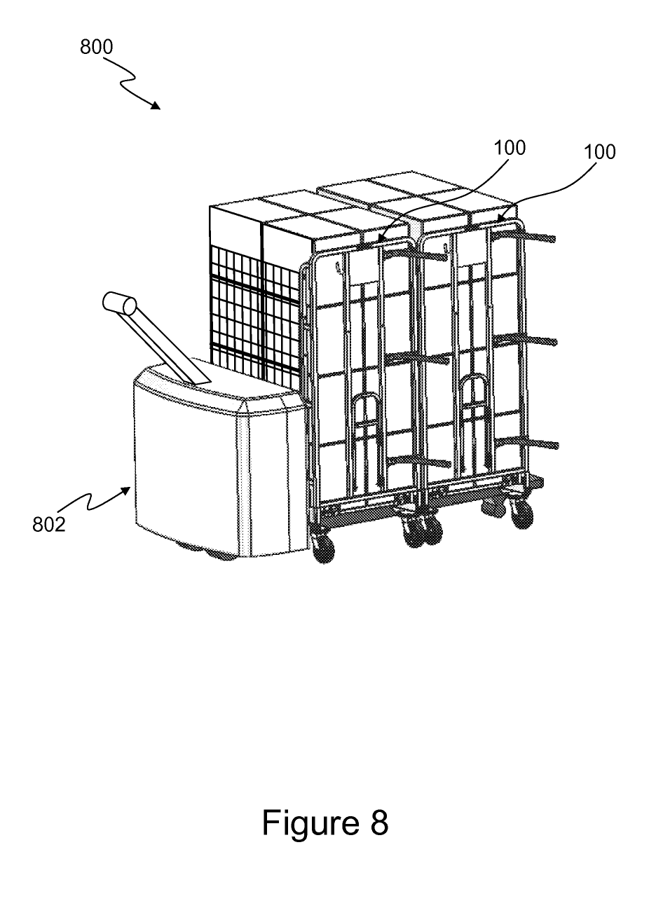

In one embodiment, multiple material handling carts 100 may be loaded with materials and arranged in a side-by-side configuration such that minimal space is wasted between adjacent material handling carts 100 (i.e., such that the number of material handling carts 100 that can be arranged in a given space, such as a truck bed, is facilitated to be maximized). The space is facilitated to be maximized due, at least in part, to the fact that shelf 206 is substantially rectangular in shape and the fact that lift assist handle 224 can be secured in substantially the same plane as inner frame members 210, 212 to minimize protrusions from material handling cart 100 (i.e., to create a substantially flat surface of material handling cart 100). In one embodiment, as shown in FIG. 8, the substantially rectangular shape of material handling cart 100 enables a plurality 800 of loaded material handling carts 100 to be lifted side-by-side via a lift apparatus (e.g., a fork lift 802). Additionally, in some embodiments, base frame 202 and/or shelf 206 may have a robust design that enables base frame 202 and/or shelf 206 to withstand repeated lifting via fork lift 802.

When rolling material handling cart 100 between locations, the user may encounter an obstacle (e.g., a street curb or a door threshold). To traverse the obstacle, the user may orient material handling cart 100 such that first caster assembly 256 and second caster assembly 258 contact the obstacle. With first caster assembly 256 and second caster assembly 258 in contact with the obstacle, the user may pivot lift assist handle 224 from the stowed position into the lift position, and the user may grasp upper arm 230 and/or lower arm 232 to facilitate lifting first caster assembly 256, second caster assembly 258, third caster assembly 260, and/or fourth caster assembly 262 over the obstacle. Alternatively, the user may gasp upper arm 230 and/or lower arm 232 to facilitate lifting first caster assembly 256 and second caster assembly 258 over the obstacle, and the user may then walk around material handling cart 100 to push the remaining portions of material handling cart 100 over the obstacle (e.g., to push third caster assembly 260 and fourth caster assembly 262 over the obstacle). After traversing the obstacle, the user may pivot lift assist handle 224 back into the stowed position in which lift assist handle 224 is removably (e.g., magnetically) held until another obstacle is encountered.

Upon reaching a location in which the user desires to unload the materials from material handling cart 100, the user lessens a tension of tie-down straps 304 such that net 302 is loosened about the load of materials. The user then removes hooks 308 from hoops 316 and brings staff 314 back toward second guiderail 236 such that net 302 does not interfere with the unloading of materials from material handling cart 100. Once the materials are unloaded from material handling cart 100, the user may either use material handling cart 100 to transport a subsequent load of materials or store material handling cart 100 for later use. When a load of materials is not secured on material handling cart 100 via net 302 (i.e., when a user is between loads or when material handling cart 100 is not in use), net 302 may be rolled about staff 314 such that staff 314 is brought back toward second guiderail 236 to be hung from hanger 218 with net 302 in the rolled configuration, thereby enabling the user to move material handling cart 100 without interference from net 302. Similarly, when a load of materials is not secured on material handling cart 100 via net 302, tie-down straps 304 may be either permitted to hang loosely adjacent first inner frame member 210 or secured to any suitable portion of support frame 204 via hooks 308. Additionally, net 302 may be removed and/or replaced by unfastening the bolts that couple second end 312 of net 302 to second guiderail 236 and by fastening (e.g., bolting) another net 302 to second guiderail 236.

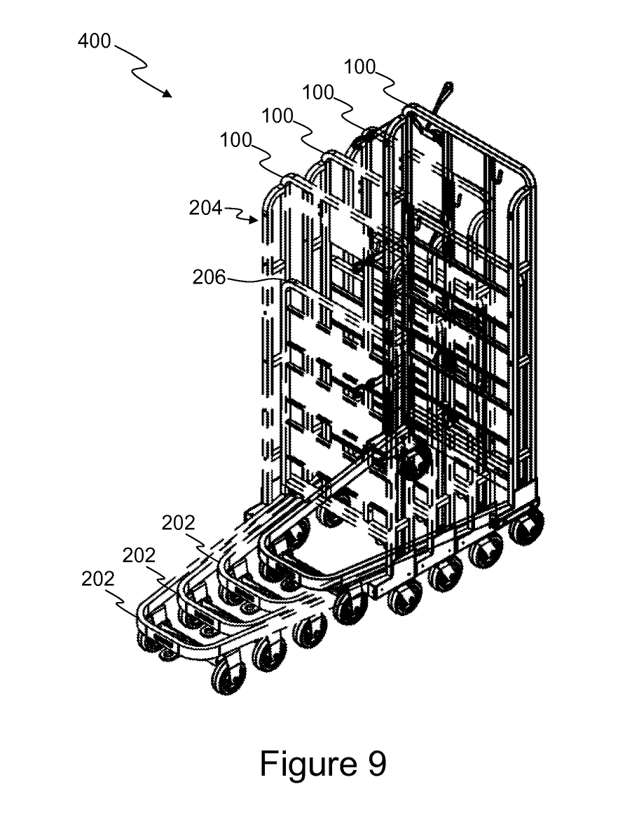

FIG. 9 is a perspective view of a plurality 400 of material handling carts 100 that are nested together. In the exemplary embodiment, when material handling cart 100 is not loaded with materials, shelf 206 may be pivoted from the lowered position into the raised position in which shelf 206 is removably (e.g., magnetically) coupled to support frame 204. With shelf 206 in the raised position, material handling cart 100 may be nested with an adjacent material handling cart 100 by inserting base frame 202 of one material handling cart 100 through first end 250 (shown in FIG. 4) and into tapered slot 254 (shown in FIG. 4) of the adjacent material handling cart 100. As such, any suitable number of material handling carts 100 may be nested together to facilitate minimizing a space requirement associated with storing material handling carts 100.

The methods and systems described herein facilitate providing a material handling cart with a reusable, adjustable, and flexible restraining member for securing a load of materials on the material handling cart during transport, thereby reducing an economic and environmental cost associated with using a different disposable restraint for each load of materials. The methods and systems described herein also facilitate providing a material handling cart with a lift assist handle to facilitate balancing and/or lifting a material handling cart over an obstacle when transporting a load of materials, thereby minimizing time and effort expended transporting a load of materials from one location to another.

Exemplary embodiments of a material handling cart and method of assembling the same are described above in detail. The methods and systems described herein are not limited to the specific embodiments described herein, but rather, components of the systems and/or steps of the methods may be utilized independently and separately from other components and/or steps described herein. For example, the methods and systems described herein may have other applications not limited to practice with material handling, as described herein. Rather, the methods and systems described herein can be implemented and utilized in connection with various other industries.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A material handling cart for transporting a load of materials, said material handling cart comprising:
a base frame;
a support frame coupled to said base frame;
a shelf coupled to at least one of said support frame and said base frame, said shelf pivotable between a raised position in which said shelf is adjacent said support frame and a lowered position in which said shelf is seated atop of said base frame, said shelf configured to receive the load of materials; and
a flexible restraining member removably coupled to said support frame, said flexible restraining member configured to be adjustably tensioned about the load of materials to secure the load of materials to said base frame and said support frame during transport.

2. A material handling cart in accordance with claim 1, wherein said flexible restraining member is a net sized to substantially envelop the load of materials.

3. A material handling cart in accordance with claim 2, wherein said support frame comprises an upper frame member opposite said base frame, said support frame having a height defined from said base frame to said upper frame member, said flexible restraining member coupled to said support frame to substantially span the height of said support frame.

4. A material handling cart in accordance with claim 1, wherein said base frame comprises a first end, a second end, and opposing sides, said first end being substantially open and proximate said support frame, wherein said base frame defines a tapered slot that tapers in a direction from said first end to said second end.

5. A material handling cart in accordance with claim 4, wherein said base frame is a first base frame associated with a first cart, and wherein said first base frame is configured to receive a second base frame associated with a second cart for nesting multiple carts.

6. A material handling cart in accordance with claim 1, wherein said shelf is configured to be magnetically coupled to said support frame when said shelf is in the raised position.

7. A material handling cart in accordance with claim 1, further comprising a lift assist handle hingedly coupled to said support frame, said lift assist handle configured to pivot between a stowed position that is substantially parallel to said support frame and a lift position that is oblique to said support frame.

8. A material handling cart in accordance with claim 7, wherein said lift assist handle is configured to be magnetically coupled to said support frame when said lift assist handle is in the stowed position.

9. A material handling cart in accordance with claim 1, wherein said base frame is a first base frame associated with a first cart, and wherein said first base frame comprises a hitch configured to couple said first cart to a second cart for moving a plurality of carts.

10. A material handling cart for transporting a load of materials, said material handling cart comprising:
a base frame;
a support frame coupled to said base frame; and
a lift assist handle hingedly coupled to at least one of said base frame and said support frame, said lift assist handle pivotable between a stowed position that is substantially parallel to said support frame and a lift position that is oblique to said support frame for lifting said material handling cart during transport.

11. A material handling cart in accordance with claim 10, wherein said lift assist handle is configured to be magnetically coupled to said support frame when said lift assist handle is in the stowed position.

12. A material handling cart in accordance with claim 10, wherein said lift assist handle is configured to be pivoted from the stowed position into an oblique orientation that is selectable from a plurality of predetermined oblique orientations.

13. A material handling cart in accordance with claim 10, wherein at least one of said support frame, said base frame, and said lift assist handle comprises a limit stop configured to limit the oblique orientation of said lift assist handle in the lift position.

14. A material handling cart in accordance with claim 10, wherein said lift assist handle comprises a proximal end and a distal end, said lift assist handle hingedly coupled to said support frame at said proximal end, said lift assist handle further comprising an upper arm proximate said distal end and a lower arm disposed between said proximal end and said upper arm.

15. A material handling cart in accordance with claim 10, wherein said lift assist handle is hingedly coupled to said support frame proximate said base frame.

16. A material handling cart in accordance with claim 10, wherein said support frame comprises a support frame outer surface and said lift assist handle comprises a handle outer surface, said support frame outer surface and said handle outer surface being substantially coplanar when said lift assist handle is in the stowed position.

17. A method of assembling a material handling cart for transporting a load of materials, said method comprising:
providing a base frame;
coupling a support frame to the base frame;
coupling a shelf to at least one of the support frame and the base frame, the shelf pivotable between a raised position in which the shelf is adjacent the support frame and a lowered position in which the shelf is seated atop of the base frame, the shelf configured to receive the load of materials; and
removably coupling a flexible restraining member to the support frame, the flexible restraining member configured to be adjustably tensioned about the load of materials to secure the load of materials to the base frame and the support frame during transport.

18. A method in accordance with claim 17, further comprising providing the flexible restraining member sized to substantially envelop the load of materials.

19. A method in accordance with claim 18, further comprising:
providing the support frame with an upper frame member opposite the base frame, the support frame having a height defined from the base frame to the upper frame member; and
coupling the flexible restraining member to the support frame to span substantially the height of the support frame.

20. A method in accordance with claim 17, further comprising hingedly coupling a lift assist handle to the support frame, the lift assist handle configured to pivot between a stowed position that is substantially parallel to the support frame and a lift position that is oblique to the support frame.
